(19) United States
(12) Patent Application Publication
(10) Pub. No.: US 2007/0089615 A1
(43) Pub. Date: Apr. 26, 2007

(54) Grind blade assembly for juice extractors

(76) Inventor: Li-chen Wu Chang, Taoyuan Hsien (TW)

Correspondence Address: LIN & ASSOCIATES INTELLECTUAL PROPERTY, P.O. BOX 2339, SARATOGA, CA, 95070-0339, US

(21) Appl. No.: 11/256,235

(22) Filed: Oct. 21, 2005

(51) Int. Cl. A23N 1/00

(52) U.S. Cl. 99/511

(57) ABSTRACT

A grind blade assembly for juice extractors includes a fixed and ring-shaped upper grind blade with first teeth located on an underside thereof and a rotatable lower grind blade which is located beneath the upper grind blade and has a plurality of second teeth defined in a ring-shaped area of a top surface of the lower grind blade. The second teeth are located corresponding to the first teeth. A plurality of first blades protrude from the top surface of the lower grind blade and located close to the center of the lower grind blade. A plurality of second blades are located between the first blades and the second teeth on the lower grind blade.

### FIELD OF THE INVENTION

The present invention relates to a grind blade assembly for juice extractors.

### BACKGROUND OF THE INVENTION

One conventional juice extractor known to applicant generally includes a motor which drives a lower grind blade and a fixed upper grind blade is located at a distance above the lower grind blade. The upper grind blade is a ring-shaped member and includes a central hole so that fruit passes through the central hole of the upper grind blade and is ground between the two grind blades. The juice is then collected from a spout and the residue is filtered by a filter. The lower grind blade is a disk with concentric teeth. Some brands have grind teeth on the bottom of the upper grind blade to further cut and grind the fruit. Some grind teeth includes grooves to allow the juice to efficiently move toward the spout.

The present invention intends to provide a grind blade assembly for juice extractors wherein the upper blade is a ring-shaped member with teeth defined in an underside thereof and the lower grind blade includes ring-shaped teeth and blades such that the fruit can be completely ground between the upper and lower grind blades.

### SUMMARY OF THE INVENTION

The present invention relates to a grind blade assembly for juice extractors and comprises a fixed and ring-shaped upper grind blade and a rotatable lower grind blade located beneath the upper grind blade. A plurality of first teeth are located on an underside of the upper grind blade and located in radial direction. A plurality of second teeth are defined in a ring-shaped area of a top surface of the lower grind blade and the second teeth are located corresponding to the first teeth. A plurality of first blades protrude from the top surface of the second grind blade and located close to the center of the second grind blade. A plurality of second blades are located between the first blades and the second teeth on the lower grind blade.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a juice extractor with the grind blade assembly of the present invention;

FIG. 2 is an exploded view to show a first embodiment of the grind blade assembly;

FIG. 3 is a cross sectional view to show the upper and lower grind blades of the grind blade assembly of the present invention;

FIG. 4 is an exploded view to show a second embodiment of the grind blade assembly;

FIG. 5 is a cross sectional view to show the upper and lower grind blades of the second embodiment of the grind blade assembly of the present invention;

FIG. 6 shows a third embodiment of the lower grind blade;

FIG. 7 shows a fourth embodiment of the lower grind blade;

FIG. 8 shows a fifth embodiment of the lower grind blade, and

FIG. 9 shows a sixth embodiment of the lower grind blade.

### DETAILED DESCRIPTION OF THE PREFERRED EMBODIMENT

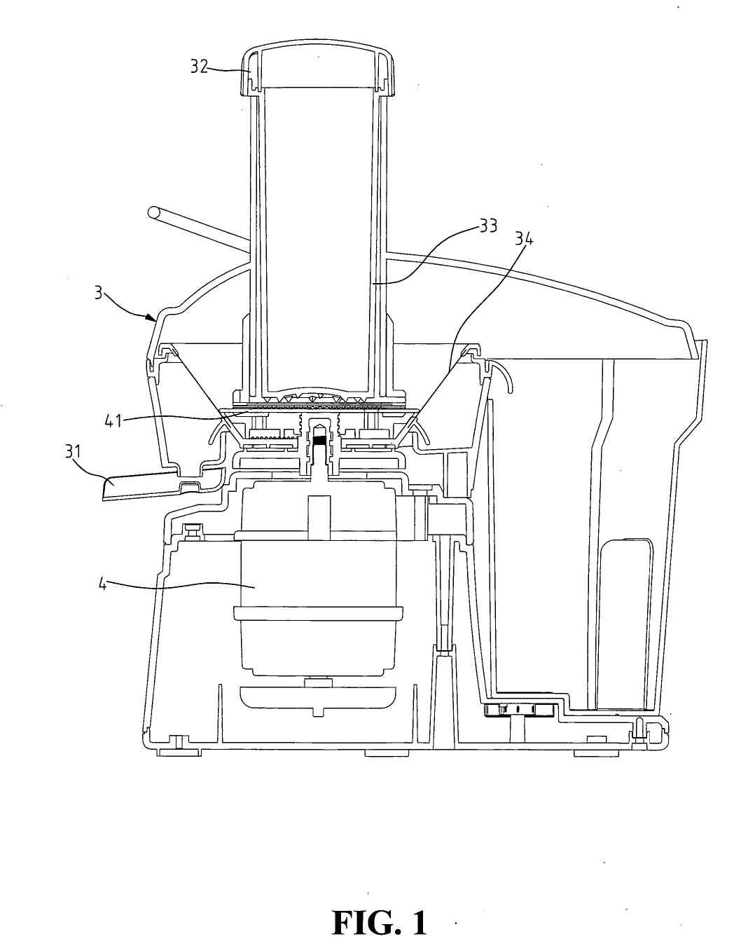

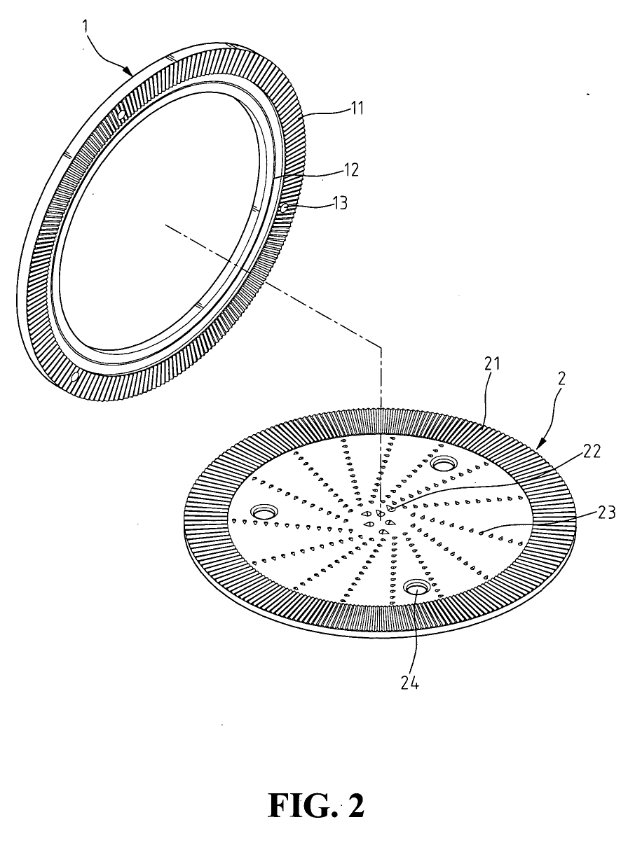

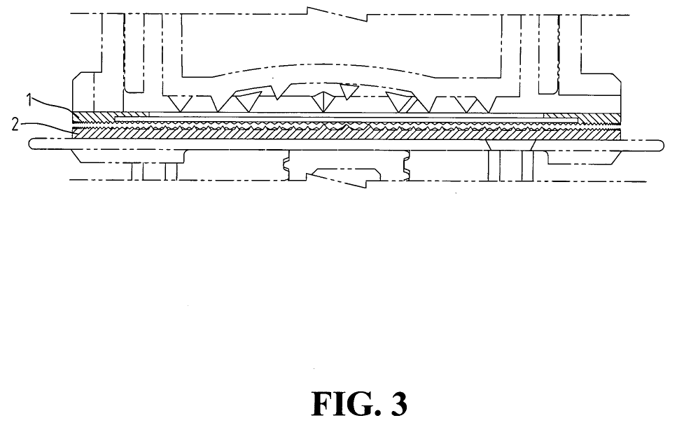

Referring to FIGS. 1 to 3, a juice extruder includes a motor 4 received in a lower portion of the extruder and an inlet 32 is defined in a top portion 3 of the extruder. Fruits can be put into the extruder via the inlet 32 and a push bar 33 is inserted into the extruder to push the fruits toward the grind blade assembly 1 which is located on the frame 41. The fruits are then ground by the grind blade assembly 1 and juice is collected from the spout 31 and the residue is filtered by a filtering member 34.

The grind blade assembly 1 of the present invention comprises a fixed and ring-shaped upper grind blade 1 and a rotatable lower grind blade 2. The upper grind blade 1 includes a plurality of first teeth 11 located on an underside thereof and the first teeth 1 are located in radial direction. A plurality of holes 13 are defined therethrough so that bolts (not shown) extend through the holes 13 to fix the upper grind blade 1 to the extruder and located around an opening defined by the inlet 32 in the top portion 3. The upper grind blade 1 includes an annular recess 12 defined in an inner periphery thereof, and an inside of the recess 12 is located deeper than the first teeth 11.

The rotatable lower grind blade 2 is a disk and located beneath the upper grind blade 1. A plurality of second teeth 21 are defined in a ring-shaped area of a top surface of the lower grind blade 2 and the second teeth 21 are located corresponding to the first teeth 11. A plurality of first blades 22 protrude from the top surface of the second grind blade 2 and are located close to the center of the second grind blade 2. A plurality of second blades 23 are located between the first blades 22 and the second teeth 21 on the lower grind blade 2. Three holes 24 are defined through the lower grind blade 2 so as to be fixed on the frame 41 by bolts. The ring-shaped area begins from an outer periphery of the lower grind blade 2 and extends towards a center of the lower grind blade 2 a first distance. The fruits are ground by the fist and second blades 22, 23 and enter into the space between the first and second teeth 11, 21 via the recess 12. The first and second teeth 11, 21 are straight teeth and extend in radial direction so that the juice can go through the paths between the straight teeth 11, 21.

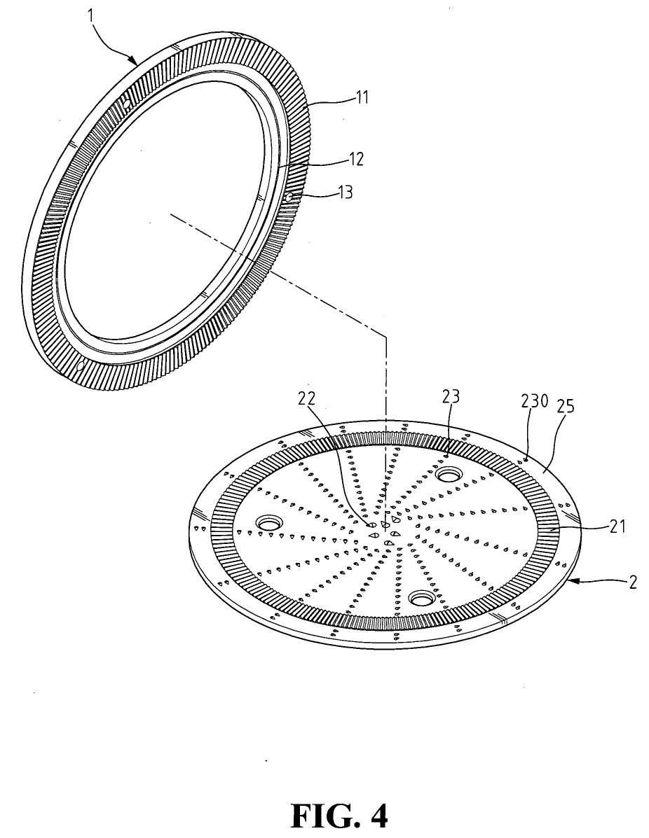

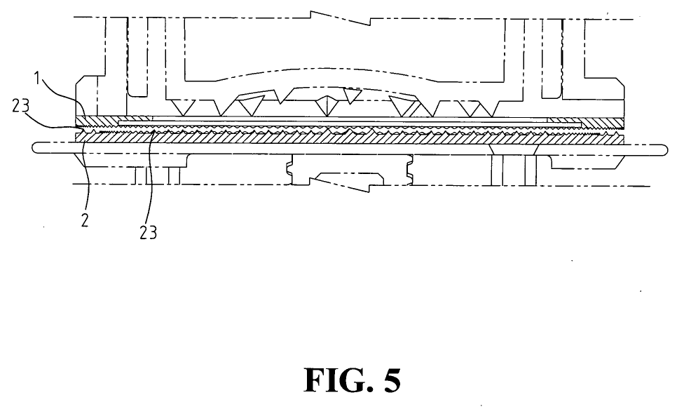

A second embodiment of the lower grind blade 2 is disclosed in FIGS. 4 and 5, wherein the ring-shaped area begins from a second distance from an outer periphery of the lower grind blade 2 and extends towards a center of the lower grind blade 2 a third distance. A plurality of third blades 230 protrude from an area between the ring-shaped area to an outer periphery of the lower grind blade 2. The third blades 230 ensure that all the fruits pieces are finely cut.

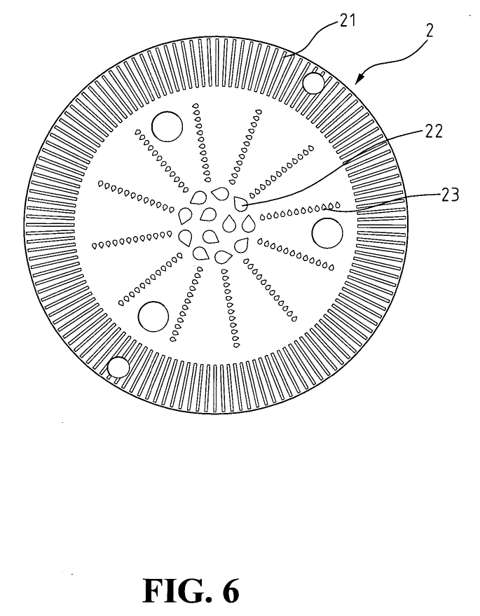

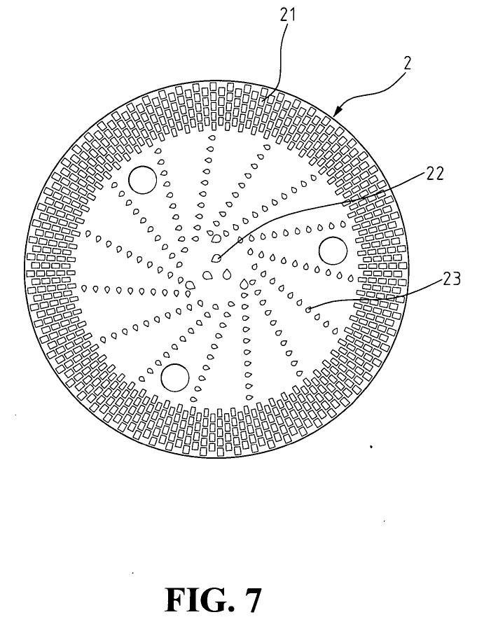

FIG. 6 shows a third embodiment of the lower grind blade 2 wherein the second teeth 21 are radial straight teeth and the first and second blades 22, 23 are located as disclosed. FIG. 7 shows a fourth embodiment of the lower grind blade 2 wherein the second teeth 21 are discontinuous teeth which are located in radial direction. Any two adjacent rows of the second teeth 21 are located alternatively from each other so that the fruits can be retained in the alternative gaps between the second teeth 21 so as to be ground for longer period of time.

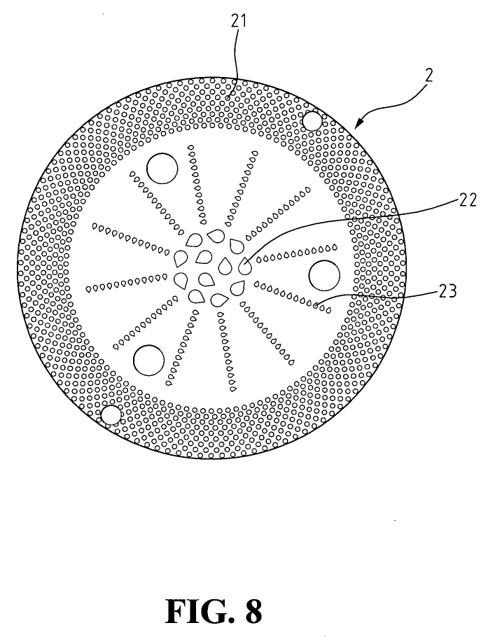

FIG. 8 shows a fifth embodiment of the lower grind blade 2 wherein the second teeth 21 are spot-shaped teeth and located alternatively to each other.

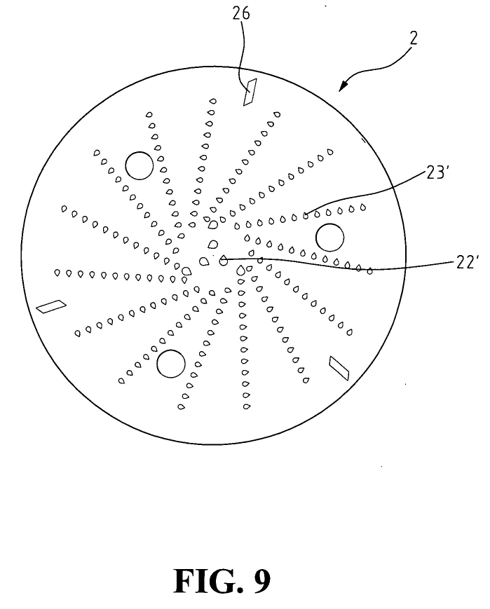

FIG. 9 shows a sixth embodiment of the lower grind blade 2 wherein a plurality of fourth blades 26 located on a top surface and close to an outer periphery of the lower grind blade 2 and a plurality of fifth blades 22′ protruding from the top surface of the second grind blade 2 and located close to a center of the second grind blade 2. A plurality of sixth blades 23′ are located between the fifth blades 22′ and the outer periphery of the second grind blade 2. The fourth blades 26 are able to cut grape stalks for example.

While we have shown and described the embodiment in accordance with the present invention, it should be clear to those skilled in the art that further embodiments may be made without departing from the scope of the present invention.

1. A grind blade assembly for juice extractors, comprising:
a fixed and ring-shaped upper grind blade and a plurality of first teeth located on an underside of the upper grind blade and located in radial direction;
a rotatable lower grind blade being a disk and located beneath the upper grind blade, a plurality of second teeth defined in a ring-shaped area of a top surface of the lower grind blade and the second teeth being located corresponding to the first teeth, a plurality of first blades protruding from the top surface of the lower grind blade and located close to the center of the lower grind blade, a plurality of second blades located between the first blades and the second teeth on the lower grind blade;
wherein the first blades and the second blades have different sizes and are distributed differently with different densities on the lower grind blade.

2. The assembly as claimed in claim 1, wherein the ring-shaped area begins from an outer periphery of the lower grind blade and extends towards a center of the lower grind blade a first distance.

3. The assembly as claimed in claim 1, wherein the ring-shaped area begins from a second distance from an outer periphery of the lower grind blade and extends towards a center of the lower grind blade a third distance, a plurality of third blades protrude from an area between the ring-shaped area to an outer periphery of the lower grind blade.

4. The assembly as claimed in claim 1, wherein the upper grind blade includes an annular recess defined in an inner periphery thereof, an inside of the recess is located deeper than the first teeth.

5. The assembly as claimed in claim 1, wherein the second teeth are straight teeth and extend in radial direction.

6. The assembly as claimed in claim 1, wherein the second teeth are discontinuous teeth which are located in radial direction.

7. The assembly as claimed in claim 6, wherein any two adjacent rows of the second teeth are located alternatively from each other.

8. The assembly as claimed in claim 1, wherein the second teeth are spot-shaped teeth.

9. A grind blade assembly for juice extractors, comprising:
a fixed and ring-shaped upper grind blade and a plurality of first teeth located on an underside of the upper grind blade and located in radial direction;
a rotatable lower grind blade being a disk and located beneath the upper grind blade, a plurality of fourth blades located on a top surface and close to an outer periphery of the lower grind blade and a plurality of fifth blades protruding from the top surface of the lower grind blade and located close to a center of the lower grind blade, a plurality of sixth blades located between the fifth blades and the outer periphery of the lower grind blade;
wherein the fourth blades the fifth blades and the sixth blades have different sizes and are distributed differently with different densities on the lower grind blade.
